(19) United States
(12) Patent Application Publication
(10) Pub. No.: US 2014/0055321 A1
(43) Pub. Date: Feb. 27, 2014

(54) IMAGE PROCESSING APPARATUSES AND EXTERNAL IMAGE APPRATUS

(71) Applicant: Silicon Motion, Inc., Jhubei City (TW)

(72) Inventor: Hao WANG, Shanghai (CN)

(73) Assignee: Silicon Motion, Inc., Jhubei City (TW)

(21) Appl. No.: 13/935,893

(22) Filed: Jul. 5, 2013

(30) Foreign Application Priority Data
Aug. 22, 2012 (CN) 201210300934.8

(51) Int. Cl. G06F 3/14

(52) U.S. Cl. CPC G06F 3/1431
USPC 345/1.1

(57) ABSTRACT

An apparatus includes at least an image drawing request reception unit, an instruction generation unit, an encoding unit and a transmission unit. The image drawing request reception unit is configured to receive an image drawing request. The instruction generation unit is configured to connect to the image drawing request reception unit and generate at least one hardware instruction according to the image drawing request. The encoding unit is configured to convert the at least one hardware instruction into a transmission data. The transmission unit is configured to transmit the transmission data to the external image device through a transmission interface. The external image device obtains the at least one hardware instruction by decoding the transmission data and drives an image processing hardware of the external image device to generate a display image according to the hardware instruction.

### CROSS REFERENCE TO RELATED APPLICATIONS

This Application claims priority of China Patent Application No. 201210300934.8, filed on Aug. 22, 2012, the entirety of which is incorporated by reference herein.

### BACKGROUND

1. Technical Field

The present invention relates to an image processing apparatus and an external image apparatus, and in particular it relates to an image processing apparatus capable of transmitting image data efficiently, since an external image apparatus performs heavy image computations.

2. Description of the Related Art

Many different electronic devices need displays. Sometimes, for the purpose of easy portability, these displays are made to be small enough to be installed in portable electronic devices, such as netbooks, which are mainly used to surf the Internet, tablet PCs (personal computers) or mobile phones. Nowadays, the processing capabilities of portable electronic devices have been greatly improved, and thus they can provide high-resolution images to be displayed on an external display via an output interface.

The external displays may be LCD (liquid crystal display) monitors, televisions, projectors, and the like. The typical interface being utilized to connect to the external display may be DVI (digital visual interface), HDMI (High-Definition Multimedia Interface), Thunderbolt, and the like. Another typical way to connect is to provide an external video adaptor, in which one end connects to the portable electronic device via a USB (universal serial bus) interface, and the other end connects to the external display, such that the images received from the portable electronic device are further processed and output to the external display.

Although it is convenient to use a USB interface or the like to output images to an external video adaptor, the image refresh rate is not high enough due to the limitations of the transmission rate of USB interfaces and the like.

In addition to the requirement for including the USB (or the like) interface, it is also necessary to pass through a wired or wireless network to transmit images from one electronic device to another. This may result in problems in obtaining a smooth display due to the excessive amount of transmitted data when the displayed images are transmitted with its original content.

Thus, it is necessary to address the above-mentioned drawbacks and provide apparatuses with the capability of efficiently transmitting images and methods thereof.

### BRIEF SUMMARY

An embodiment of an apparatus for contributively modifying an image orientation is introduced. A display processing unit thereof receives an image stream from an external apparatus through a transmission interface and generates an image accordingly.

An apparatus for processing and outputting image data to an external image device is introduced according to an embodiment of the invention. The apparatus includes at least a image drawing request reception unit, an instruction generation unit, an encoding unit, and a transmission unit. The image drawing request reception unit is configured to receive an image drawing request. The instruction generation unit is configured to connect to the image drawing request reception unit and generate at least one hardware instruction according to the image drawing request, such as two dimension graphical acceleration instructions, three dimension graphical acceleration instructions or other graphical acceleration instructions, for example, decoding instructions for compressed images. The encoding unit is configured to connect to the instruction generation unit and convert the hardware instruction(s) into transmission data. The transmission unit is configured to connect to the encoding unit, and transmit the transmission data to the external image device through a transmission interface. The external image device obtains the hardware instruction(s) by decoding the transmission data, and it drives an image processing hardware of the external image device to generate a display image according to the hardware instruction(s).

In an exemplary practice, the image drawing request is generated by an OS (operating system) being executed, the image drawing request reception unit receives the image drawing request via a hardware driving procedure being executed, and the hardware driving procedure generates a corresponding hardware instruction with reference made to the image drawing request.

In addition, the transmission interface, depending on different design requirements, may be a wired network such as Ethernet or others, a wireless network such as WiFi or others, or a transmission interface such as USB (universal serial bus), and is used to connect a local electronic device to an external video adaptor.

On top of that, the encoding unit may further append image data corresponding to the hardware instruction into the transmission data, and may further compresses the transmission data to reduce its length in generating the transmission data.

An apparatus for connecting to a local electronic device, processing and outputting image data to an external image device is introduced according to another embodiment of the invention. The apparatus includes at least a local interface and a transmission unit. The local interface is configured to receive transmission data comprising at least one hardware instruction from the local electronic device. The transmission unit is configured to transmit the transmission data to the external image device via a transmission interface. The external image device obtains the hardware instruction(s) by decoding the transmission data, and it drives an image processing hardware of the external image device to generate a display image for use according to the hardware instruction(s).

An apparatus for connecting to a local electronic device via a transmission interface and outputting images is introduced according to still another embodiment of the invention. The apparatus includes at least a display unit, a reception unit, a decoding unit, and an image processing hardware. The reception unit is configured to receive transmission data via the transmission interface, where the transmission data comprises at least one hardware instruction and image data corresponding to the hardware instruction(s). The decoding unit is configured to obtain the corresponding image data and the hardware instruction(s) from the transmission data. The image processing hardware is configured to generate a display image according to the hardware instruction(s) and the corresponding image data and display the display image on the display unit.

The embodiments of the invention utilize the hardware acceleration capability of an external device to avoid having the local apparatus bear most of the load of the graphical computation. Moreover, since the transmission content includes hardware instructions rather than raw display images, the required transmission bandwidth can be reduced due to the lighter transmission data, and the images can be displayed more smoothly without being hindered by a narrower transmission bandwidth.

A detailed description is given in the following embodiments with reference to the accompanying drawings.

### BRIEF DESCRIPTION OF THE DRAWINGS

The present invention can be fully understood by reading the subsequent detailed description and examples with references made to the accompanying drawings, wherein:

FIG. 1 illustrates the system deployment according to an embodiment of the invention;

FIG. 2 illustrates the hardware architecture of an electronic device according to an embodiment of the invention;

FIG. 3 illustrates the software architecture according to an embodiment of the invention;

FIG. 4 illustrates the flowchart according to an embodiment of the invention;

FIG. 5 illustrates the system deployment according to another embodiment of the invention;

FIG. 6 illustrates the schematic diagram of data transmission between the local and external electronic devices according to an embodiment of the invention;

FIG. 7 illustrates the system deployment according to still another embodiment of the invention; and

FIG. 8 illustrates the system deployment according to still another embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. The drawings described are only schematic and are non-limiting. In the drawings, the size of some of the elements may be exaggerated and not drawn to scale for illustrative purposes. The dimensions and the relative dimensions do not correspond to actual dimensions to practice the invention.

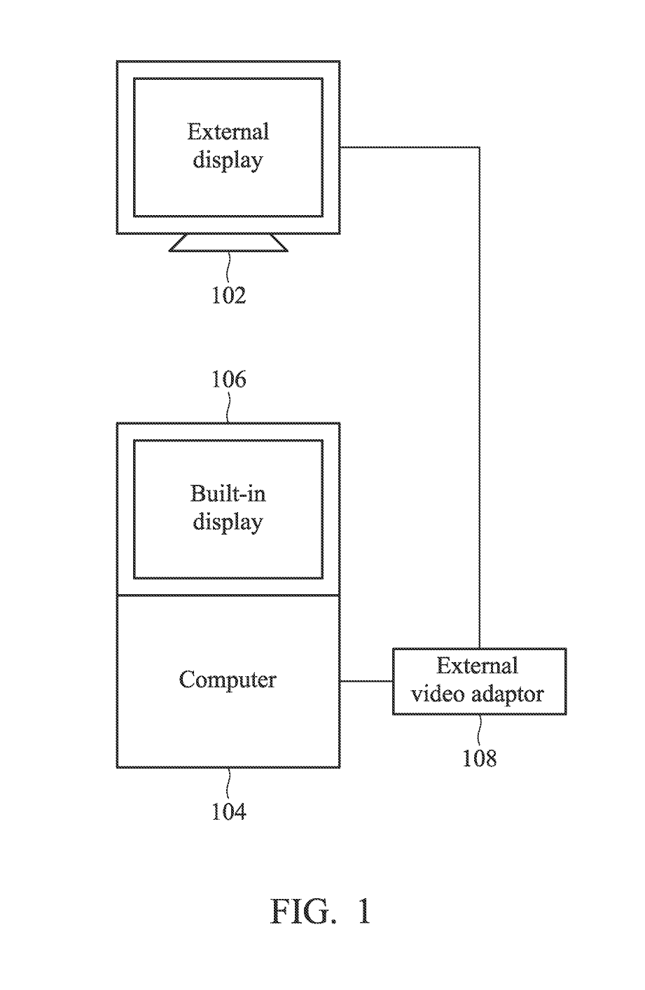

Referring to FIG. 1, the system architecture of an embodiment of the invention is illustrated. The computer 104 comprises a built-in display 106, and couples or connects to an external display 102 via an external video adaptor 108. In the embodiment, the external video adaptor 108 couples or connects to the computer 104 via a USB (universal serial bus) interface, and couples or connects to the external display 102 via a DVI (digital visual interface) interface. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

In the embodiment, the computer 104 may be a typical notebook computer. While the embodiment is described herein with respect to a notebook computer, it should be apparent that the disclosed implementations can be incorporated in, or integrated with, any electronic device that is capable of computing, including but not limited to a desktop computer, a multimedia player, a tablet PC, a mobile phone, etc.

In the embodiment, the computer 104 is equipped with a built-in display 106. Although the computer has been described as having specific features, such as the built-in display, it should be apparent that the disclosed implementations may not necessarily provide it. For example, an optical disk player or a set-top box may utilize the external display 102 as its only main display.

In the embodiment, the external video adaptor 108 is located outside of and connects to the computer 104. Alternatively, in some implementations, those who are skilled in the art may install the video adaptor 108 in the computer 104 as its entirety. In some other implementations, those skilled in the art may install the video adaptor 108 in the external display 102 as its entirety.

In the embodiment, the external display 102 has a display panel. While the embodiment is described herein with respect to a display having a display panel, it should be apparent that the disclosed implementations can be incorporated in, or integrated with, any electronic device that is capable of video processing, including but not limited to a projector or a video recorder capable of receiving image data and recording video or image streams, etc.

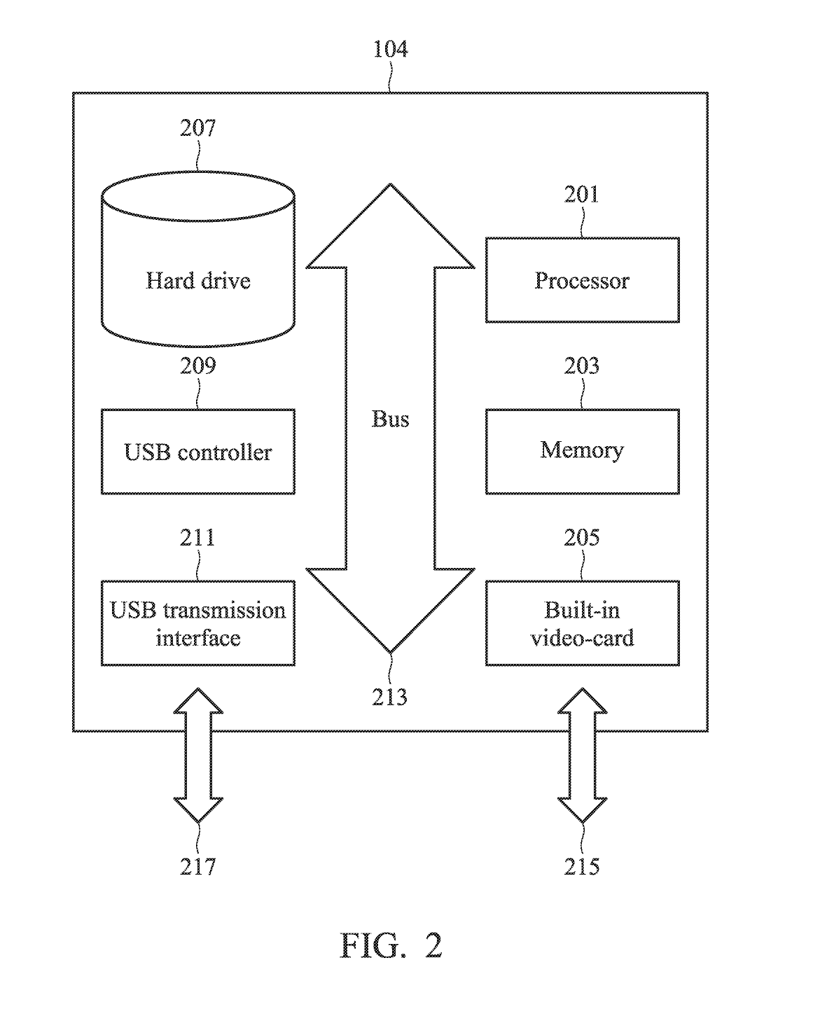

Please refer to FIG. 2. FIG. 2 is a schematic diagram of feasible hardware architecture of the computer 104 as shown in FIG. 1.

In the exemplary FIG. 2, the computer 104 comprises a processor 201, a memory 203, a built-in video-card 205, a hard drive 207, a USB controller 209, and a USB transmission interface 211. The processor 201 loads program code from the hard drive 207 into the memory 203 and executes a wide range of computing operations as required.

Typically, a portion of the computing operations comprise generating image data to be transmitted to the built-in video-card 205 via a bus 213. The built-in video-card 205 processes the image data to generate and transmit a corresponding image or video stream 215 to the built-in display 106 as shown in FIG. 1.

The processor 201 may determine if the external video adaptor 108 as shown in FIG. 1 has been coupled or connected to the processor 201 through the USB transmission interface 211 and the USB controller 209. If so, the processor 201 generates the required image data in light of the read-out program code. The image data is transmitted to the USB transmission interface 211 via the bus 213 and is further transmitted to the external video adaptor 108 as shown in FIG. 1. The external video adaptor 108 processes the received image data, transforms the processed one into a corresponding image stream, and further transmits the transformed one to the external display 102 for display.

While modules 201 to 217 are described in the computer 104, as shown in FIG. 2, it should be apparent that any of the modules 201 to 217 can be removed or replaced with another element based on different implementation requirements without departing from the spirit of the present invention. For example, it should be appreciated that, instead of the USB transmission interface 211, the peripheral interface may be a thunderbolt interface, a commonly used composite video interface, a proprietary interface, etc. As mentioned above, while the embodiment is described herein with respect to the computer 104, it should be apparent that the disclosed implementations can be incorporated in, or integrated with, any electronic device that is capable of computing, including a mobile phone. In the case of a mobile phone, all or a portion of the modules illustrated in FIG. 2 may be incorporated in an IC (integrated circuit) chip.

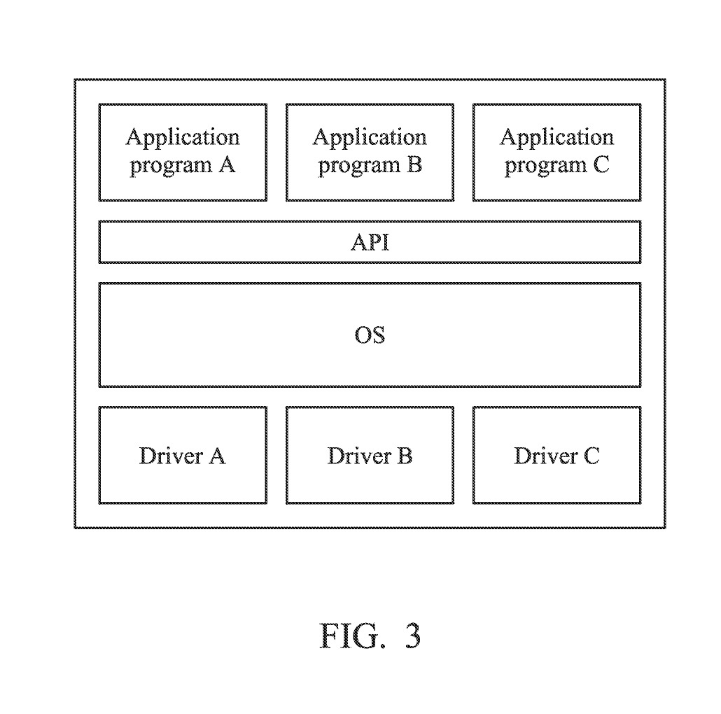

Please refer to FIG. 3. FIG.3 illustrates an embodiment of feasible software architecture of the computer 104 as shown in FIG. 2.

In FIG. 3, an OS (operating system) is installed in the computer and communicates with a wide range of hardware modules through driving procedures A, B, and C. On the other hand, the OS communicates with application programs A, B, and C through an API (application-programming interface). By using this sort of software architecture, the computer 104 as shown in FIG. 1 can complete the designated tasks in order.

In the embodiment, the external video adaptor 108 may already be supported by the OS and the user has no need to install a corresponding driving procedure in computer 104. It will be appreciated that, in an alternative embodiment, in a situation in which the OS does not support the external video adaptor 108, it may need a corresponding driving procedure to be installed by the user, such that the OS can know how to communicate with the external video adaptor 108.

For example, with the usage of an interface provided by the OS, the external display 102 may be configured to display the same content as that as shown on the built-in display 106. Or the user may interact with the interface to configure the external display 102 to display different content from that shown on the built-in display 106 to display more information. It is also possible to configure it so that the external display 102 is dedicated to displaying output of a particular application program, such as video stream playback.

The driving procedure may provide messages to the OS for further judgment and process. However, the driving procedure may handle part of the communications with the external video adaptor 108 and has no need to pass all messages to the OS, depending on different design requirements.

In the detailed examples to be described below, a portion of the process of the external adaptor 108, as required, may be handled by the corresponding driving procedure.

Source code for the driving procedure may be provided by the manufacturer of the external video adaptor 108 with an optical disk, downloaded from a particular website by users, or delivered via other media. The driving procedure code may be written and distributed by a third party.

In the embodiment, the software, in the conceptual perspective, is separated by multiple modules in multiple layers. The above separation is not exhaustive, and it should be understood that those who are skilled in the art may modify the above-mentioned software architecture to fulfill particular requirements. Alternatively, all or part of the modules illustrated therein can be implemented by hardware circuits.

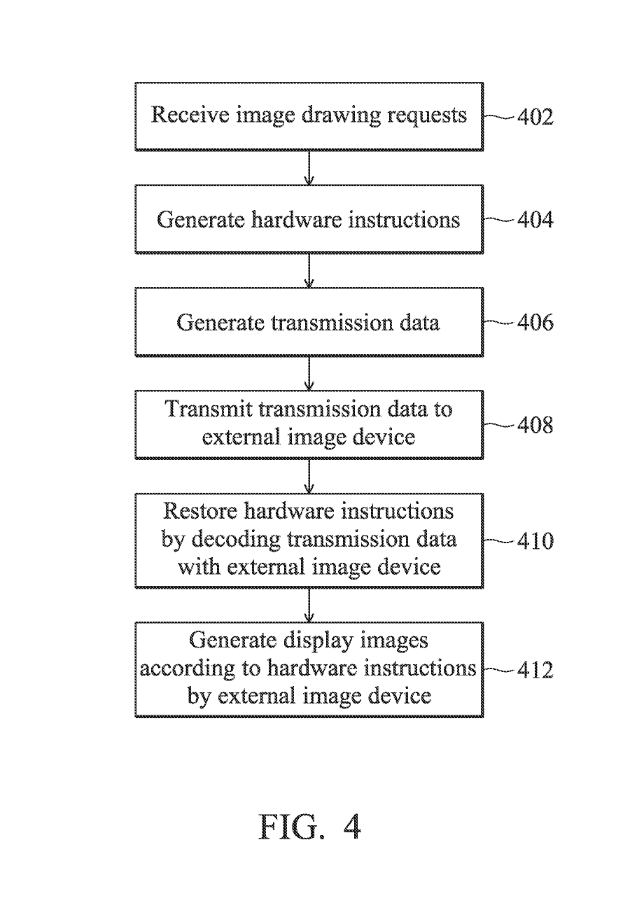

Please refer to FIG. 4. FIG. 4 is a flowchart illustrating an embodiment of a method that is executable in the exemplary architectures of FIGS. 1 to 3.

Image drawing requests are generated by a wide range of application programs. For example, an application program needs to draw hundreds of rectangles or other rectangular shapes in different colors in image generation. In another example, the application program of a racing game needs to generate partial images for auto parts of a car or scene images. In still another example, an application program for ordinary image processing needs to produce geometric vector shapes in multiple layers drawn by users.

If the image drawing requests ask for drawing images locally, the requested tasks may be passed to a built-in video card with corresponding private driving procedures or public driving procedures, such as the Direct X interface of Microsoft windows®. If the images are required to be shown on an externally connected display, the conventional way is to process the image drawing requests locally and, after completion, the local processing circuits transmit the display images to the externally connected display.

The externally connected display may be connected to the local electronic device through an external video adaptor, or connected to a remote computer or the display of another electronic device through Ethernet, WiFi, etc.

In an exemplary practice, the image drawing requests are generated by the OS as shown in FIG. 3, or by any application program and transmitted to a driving procedure corresponding to an external image device via the OS.

After receiving the image drawing requests (step 402), the driving procedure does not process directly to generate the corresponding display images by using local image processing hardware. Instead, the driving procedure converts the image drawing requests into corresponding hardware instructions (step 404).

The exemplary hardware instructions comprises two dimension graphical acceleration instruction, three dimension graphical acceleration instruction, or others instructions for decoding compressed images.

The content of the hardware instructions embodied in a specific format is generated by the driving procedure and conforms to the external image device. If the image processing hardware of the local device and the external image device utilize the same format for hardware instructions, there is no need to perform any format conversion. Otherwise, even both the local device and the external image device have their image processing hardware, the driving procedure has to convert the hardware instructions into another format recognized by the image processing hardware of the external image device.

After the generation of the corresponding hardware instructions, the hardware instructions and the image data corresponding thereto are encoded as transmission data (step 406). The transmission data may be further compressed to reduce its length. The transmission data is transmitted to the external image device through a transmission interface (step 408).

With reference made to FIG. 1, the external image device may be mapped to the external video adaptor 108, or a collection of the external video adaptor 108 and the external display 102. On top of that, the transmission interface may be USB or the like.

After receiving the transmission data, the external image device decodes the received data to restore the hardware instructions and the image data corresponding thereto (step 410). In some cases, there may be no additional image data and it is sufficient to generate display images in light of the hardware instructions only.

The external image device uses the hardware instructions and the image data corresponding thereto to generate the corresponding display image (step 412).

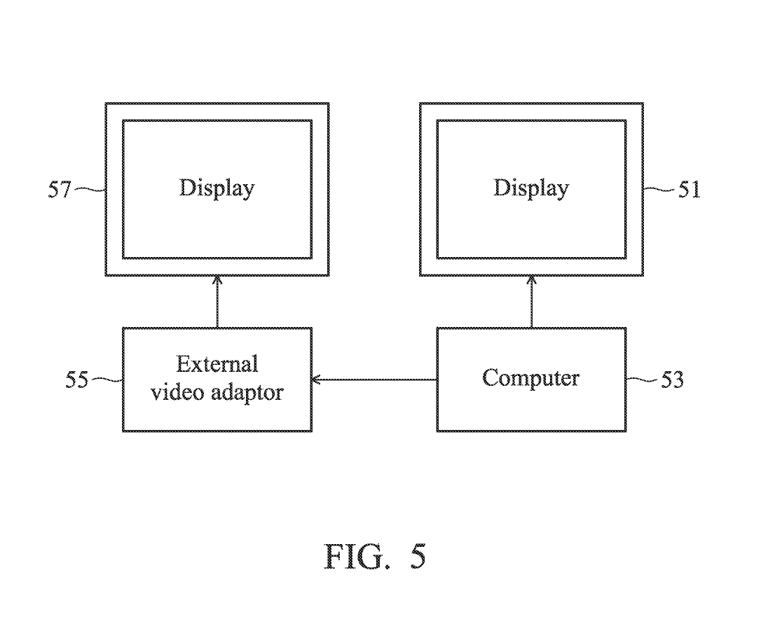

Please refer to FIG. 5 illustrating system architecture according to an embodiment of the invention.

The system architecture of FIG. 5 describes a practical component deployment of the invention. A computer 53, on the one hand, displays images on the display 51, and, on the other hand, an application program or the OS of the computer 53 generates an image drawing request for display images to be displayed on the display 57.

The image drawing request is not directly and fully processed by computations in the computer 53 to generate the display images. Instead, the image drawing request is computed to generate hardware instructions. The hardware instructions can be executed by an image processing hardware of an external video adaptor 55.

An alternative way to conform to the spirit of the invention is that the hardware instructions are transmitted to the external video adaptor 55, and are transcoded into relevant content embodiments in a specific format recognized by the image processing hardware of the external video adaptor 55.

Through embodiments illustrated with FIGS. 1 to 5, the computer 53 does not need to complete all image computations. Transmission of the hardware instructions consumes less bandwidth than directly transmitting display images. Thus, even the transmission interface having a narrower transmission bandwidth like USB can be practiced to smoothly provide display images.

While the above image processing methods and apparatuses are described in examples according to the invention, it should be apparent that several implementations can be adopted as follows.

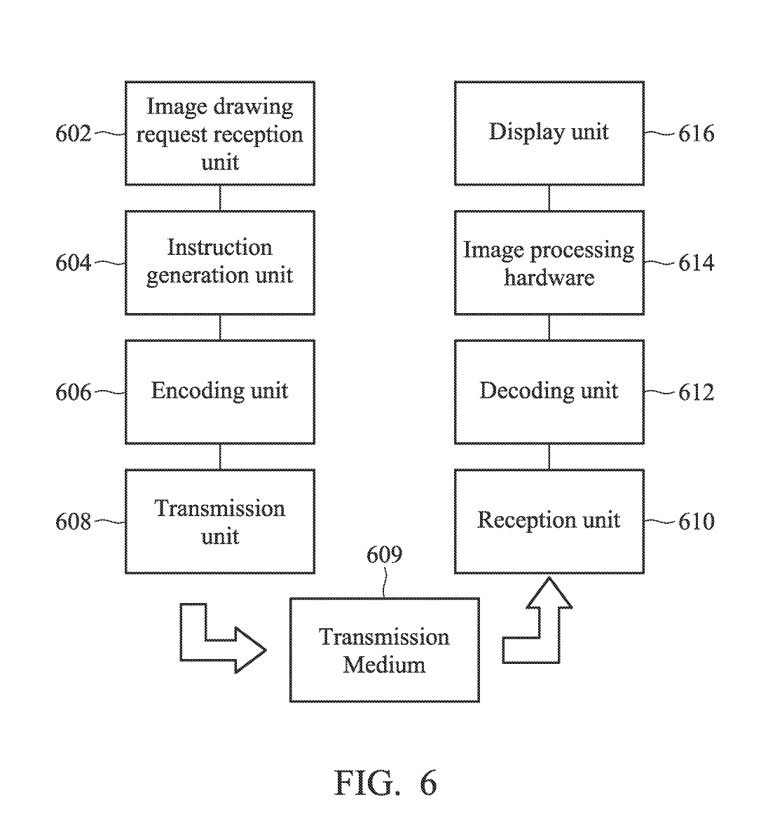

FIG. 6 illustrates a generic architecture for image processing enclosed in the above exemplary apparatuses of the invention. An image processing device as shown in the left side of FIG. 6 includes an image drawing request reception unit 602, an instruction generation unit 604, an encoding unit 606, and a transmission unit 608.

The image drawing request reception unit 602 receives an image drawing request. The instruction generation unit 604 generates one or more hardware instructions according to the received image drawing request. The encoding unit 606 encodes the hardware instructions as corresponding transmission data. It is also feasible to further compress the transmission data to reduce its length. The transmission unit 608 transmits the transmission data to an external image device via a transmission interface through a transmission medium.

In some situations, the transmission data includes not only the hardware instructions but also image data corresponding thereto. For example, a hardware instruction instructs to draw a rectangle and the corresponding image data contains a texture pattern to fill the rectangle.

An external image device as shown on the right side of FIG. 6 includes a reception unit 610, a decoding unit 612, image processing hardware 614, and a display unit 616. The process begins with the reception unit 610 receiving image data. The decoding unit 612 restores the corresponding hardware instructions and image data. The hardware instructions are passed to the image processing hardware 614 to generate the corresponding display images. The display images are stored in a frame buffer and displayed by the display unit 616.

While the embodiment is described herein with respect to the display unit 616 is used to display the display images, it should be apparent that the disclosed implementations can be incorporated in, or integrated with, any electronic device including but not limited to a projector, a printer, a video recorder, or other electronic devices capable of outputting images.

The mentioned transmission medium 609 may include signal wire or air in accordance with the transmission interface. Another example of a different transmission medium is described with reference made to the following figure.

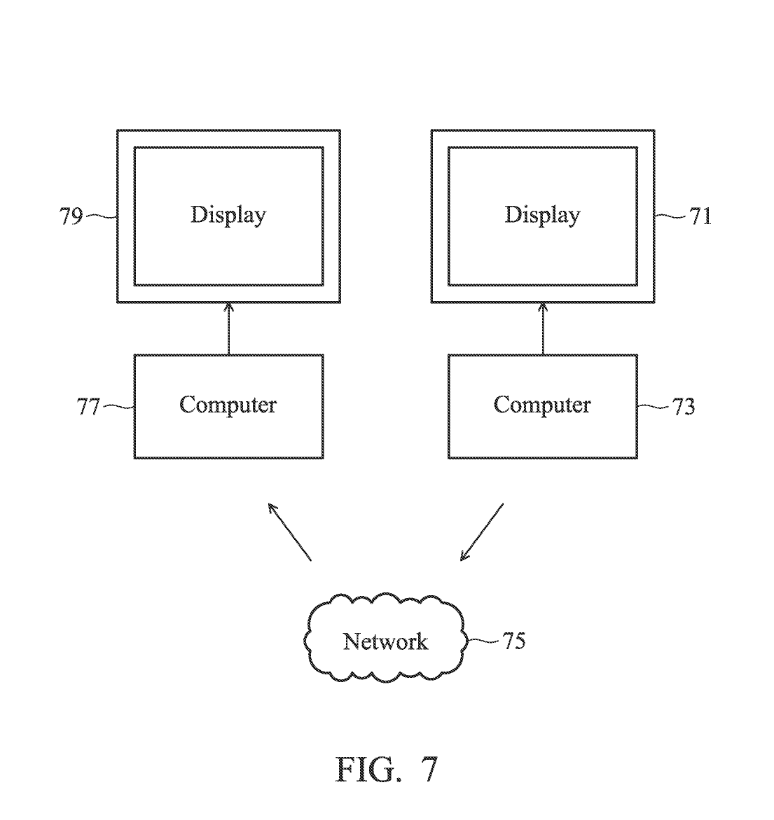

In the example of FIG. 7, the computer 73, on the one hand, displays images on the display 71, and, on the other hand, an application program or the OS of the computer 73 generates an image drawing request for display images to be displayed on the display 79. Unlike the previous examples containing a USB interface, the transmission interface of the example herein is Ethernet, WiFi or other networks.

Corresponding with the above transmission medium, an image drawing request is first generated and the corresponding hardware instructions are computed. Meanwhile, the hardware instructions are packetized into TCP/IP (transmission control protocol/Internet protocol) packets or network data in a different format, and then the TCP/IP packets are transmitted to the computer 77 through the network 75.

The computer 77 begins to decode the transmission to restore the corresponding hardware instructions and image data corresponding thereto. The hardware instructions and the corresponding image data are processed by an image processing hardware of the computer 77 to generate a corresponding display image. The display images are finally displayed on the display 79.

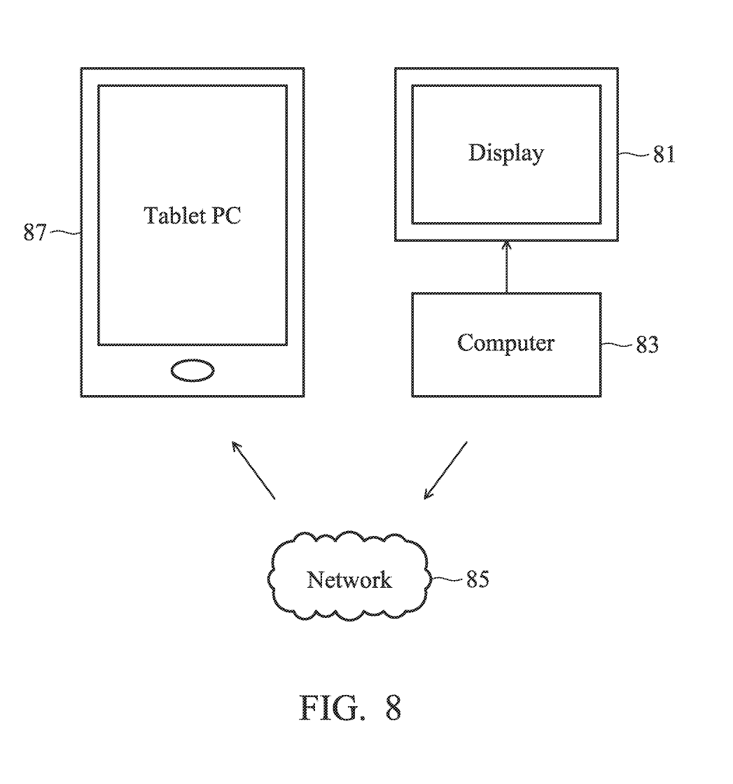

FIG. 8 illustrates another example of an external display. A tablet PC 87 in FIG. 8 is operated as an external display. The computer 83 transmits transmission data to the tablet PC 87 through a network 85, and the tablet PC 87 decodes the transmission data to restore the corresponding hardware instructions. The hardware instructions are computed by image processing hardware thereof to obtain and display the images thereon. The display images shown on the tablet PC 87 are not necessarily the same as those displayed on the display 81 directly connected to the PC 83 in local.

The above-described embodiments of the present invention can be implemented in any of numerous ways. For example, the embodiments may be implemented using hardware, software, or a combination thereof. It should be appreciated that any component or collection of components that performs the functions described above can be generically considered as one or more controllers that control the above-discussed function. One or more controllers can be implemented in numerous ways, such as with dedicated hardware, or with general-purpose hardware (e.g., one or more processor) that is programmed using microcode or software to perform the functions recited above.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for processing and outputting image data to an external image device, comprising:
an image drawing request reception unit configured to receive an image drawing request;
an instruction generation unit configured to connect to said image drawing request reception unit and generate at least one hardware instruction according to said image drawing request;
an encoding unit configured to connect to said instruction generation unit and convert said at least one hardware instruction into a transmission data; and
a transmission unit configured to connect to said encoding unit, transmit said transmission data to said external image device through a transmission interface, thereby enabling said external image device to obtain said at least one hardware instruction by decoding said transmission data and drive an image processing hardware of said external image device to generate a display image according to said hardware instruction.

2. The apparatus of claim 1, wherein said image drawing request is generated by an OS (operating system) being executed thereof, said image drawing request reception unit receives said image drawing request via a hardware driving procedure being executed thereof, and said hardware driving procedure generates a corresponding hardware instruction with reference made to said image drawing request.

3. The apparatus of claim 1, wherein said hardware instruction comprises a two dimension graphical acceleration instruction.

4. The apparatus of claim 1, wherein said hardware instruction comprises a three dimension graphical acceleration instruction.

5. The apparatus of claim 1, wherein said transmission interface is a wired network.

6. The apparatus of claim 1, wherein said transmission interface is a wireless network.

7. The apparatus of claim 1, wherein said transmission interface is a USB (universal serial bus) transmission interface.

8. The apparatus of claim 1, wherein said external image device is a built-in electronic device processing said hardware instruction.

9. The apparatus of claim 1, wherein said encoding unit further append at least image data corresponding into said hardware instruction to said transmission data.

10. The apparatus of claim 1, wherein said encoding unit further compresses said transmission data to reduce its length in generation of said transmission data.

11. An apparatus for connecting to a local electronic device, processing and outputting image data to an external image device, comprising:
a local interface configured to receive a transmission data comprising at least one hardware instruction from said local electronic device; and
a transmission unit configured to transmit said transmission data to said external image device via a transmission interface, thereby enabling said external image device to obtain said at least one hardware instruction by decoding said transmission data and drive an image processing hardware of said external image device to generate a display image for use according to said hardware instruction.

12. The apparatus of claim 1, wherein an OS (operating system) of said local electronic device generates an image drawing request, and a hardware driving procedure of said local electronic device receives said drawing request and generates a corresponding hardware instruction with reference made to said image drawing request.

13. The apparatus of claim 11, wherein said local interface is USB (universal serial bus) interface.

14. The apparatus of claim 11, wherein said hardware instruction comprises a two dimension graphical acceleration instruction.

15. The apparatus of claim 11, wherein said hardware instruction comprises a three dimension graphical acceleration instruction.

16. The apparatus of claim 11, wherein said transmission data further comprises at least image data corresponding to said hardware instruction.

17. An apparatus for connecting to a local electronic device via a transmission interface and outputting images, comprising:
a display unit;
a reception unit configured to receive a transmission data via said transmission interface, wherein said transmission data comprises at least one hardware instruction and an image data corresponding to said hardware instruction;
a decoding unit configured to obtain said corresponding image data and said at least one hardware instruction from said transmission data; and
an image processing hardware configured to generate a display image according to said at least one hardware instruction and said corresponding image data and display said display image on said display unit.

18. The apparatus of claim 17, wherein said hardware instruction comprises a two dimension graphical acceleration instruction.

19. The apparatus of claim 17, wherein said hardware instruction comprises a three dimension graphical acceleration instruction.

20. The apparatus of claim 17, wherein said transmission interface is a network.
